(19) United States
(12) Patent Application Publication
(10) Pub. No.: US 2023/0303408 A1
(43) Pub. Date: Sep. 28, 2023

(54) WATER QUALITY MONITORING AND MAINTAINING SYSTEM

(71) Applicants: Wan-Zhou YU, Yilan County (TW); Ting-Yu CHEN, Yilan County (TW); Hsuan-Chung HUANG, Yilan County (TW); Shun-Qing ZHANG, Yilan County (TW)

(72) Inventors: Wan-Zhou YU, Yilan County (TW); Ting-Yu CHEN, Yilan County (TW); Hsuan-Chung HUANG, Yilan County (TW); Shun-Qing ZHANG, Yilan County (TW)

(21) Appl. No.: 17/702,844

(22) Filed: Mar. 24, 2022

(51) Int. Cl. C02F 1/00

(52) U.S. Cl. CPC C02F 1/008; C02F 2209/001; C02F 2209/003; C02F 2209/006

(57) ABSTRACT

A water quality monitoring and maintaining system includes a water quality monitoring instrument, a process system and a water quality treating module. The water quality monitoring instrument is used for collecting a plurality of water quality data of a monitored water in a monitored environment. The process system is used for processing an error correcting operation and a storing operation for the plurality of water quality data collected by the water quality monitoring instrument, thereby establishing a water quality data model. The water quality treating module is used for adjusting the plurality of water quality data of the monitored environment according to the water quality data model.

### BACKGROUND OF THE INVENTION

### 1. Field of the Invention

The present invention relates to a monitoring and maintaining system, especially to a water quality monitoring and maintaining system.

### 2. Description of Related Art

A proper cultivating environment is required to be maintained for most of the cultivating farms, so that the cultivated creatures and croppers are able to grow with an optimal quality, thereby increasing the selling price or the feed conversion rate (FCR) of each of the cultivating creatures; however, in most of the environmental factors, the water is most important factor for the cultivating industry, especially for cultivating creatures, for example fishes, mollusks, shellfishes, crustaceans, amphibians and algae, in the cultivating farms; as such, the cultivating quality would be directly affected by the monitoring and maintaining results of the water temperature and the water quality in the cultivating farm.

In the current cultivating industry, the water quality management is achieved by utilizing a water quality monitoring instrument to determine the status of the water in the cultivating farm; a conventional water quality detecting method is the electrode method, but the electrode method may cause a detecting imprecision due to the biofilm of the cultivating creature in the cultivating farm, as such, the water quality detecting contents require the professional operator to identify and determine the accuracy of the detected value based on their empirical rules, and there are many variables regarding to the empirical standard of the professional operator and the detecting environment, thus those values cannot be effectively used and the cultivating condition may not be directly adjusted.

Based on what has been disclosed above, the current water quality monitoring instrument and the related system has following problems:
1. The water quality monitoring instrument has to be manually operated for the purposes of monitoring and detecting.
2. The detecting tool (for example a carbon stick) used in the cultivating environment has to be cleaned frequently, otherwise the detecting result may easily be imprecise.
3. After the value detecting process is finished, a systematical monitoring solution for the water quality treating process may not be immediately provided.

In view of the above-mentioned disadvantages, how to provide a water quality monitoring and maintaining system for solving the aforesaid disadvantages is a major issue to be improved by the skilled people in the art.

### SUMMARY OF THE INVENTION

For solving the shortages existed in the prior art, one primary objective of the present invention is to provide a water quality monitoring and maintaining system, in which the labor consumption for an water quality monitoring process can be decreased, a system operator is provided with the data to monitor and control the current water quality for the whole cultivating farms at the same time, and the automatic solution can be immediately provided to the zone where the water quality has changed so as to achieve the water quality treating process, meanwhile with the establishment of the water quality data model, the system is able to draft a solution for a certain zone where the water quality has yet to be abnormal; and the system is able to directly link the monitored status obtained by the water quality monitoring instrument with the treating module of the system, thereby providing an automatic and comprehensive solution for the water quality monitoring and treating.

For achieving the aforesaid objective, one technical solution provided by the present invention is to provide a water quality monitoring and maintaining system including a water quality monitoring instrument, a process system and a water quality treating module. The water quality monitoring instrument is used for collecting a plurality of water quality data of a monitored water in a monitored environment. The process system is used for processing an error correcting and a storing operation for the plurality of water quality data collected by the water quality monitoring instrument, thereby establishing a water quality data model. The water quality treating module is used for adjusting the plurality of water quality data of the monitored environment according to the water quality data model.

For achieving the aforesaid objective, the water quality monitoring instrument of the water quality monitoring and maintaining system has a water inlet port, a detecting zone, a communicating zone and a water outlet port. Fluids in the water inlet port, the detecting zone and the water outlet port are in communication with each other, and the detecting zone is electrically connected to the communicating zone. The monitored water flows into the detecting zone from the water inlet port, the detecting zone is served to analyze the monitored water and send an analyzing result to the communicating zone, and then the monitored water in the detecting zone flows out from the water outlet port.

For achieving the aforesaid objective, the water quality monitoring instrument of the water quality monitoring and maintaining system further has an expanding and culturing tank, the expanding and culturing tank is used for expanding and culturing organic substances and inorganic substances for monitoring the amount of germs and viruses contained in the monitored water.

For achieving the aforesaid objective, the detecting zone of the water quality monitoring and maintaining system has a filtering and depositing tank, a separating tank, a flow channel, an optical detecting zone and a sterilizing tank. The filtering and depositing tank, the separating tank, the flow channel, the optical detecting zone and the sterilizing tank sequentially allows the fluid to pass for enabling the monitored water to flow in or flow out.

For achieving the aforesaid objective, the plurality of water quality data of the monitored water of the water quality monitoring and maintaining system include, but not limit to, single parameter or any combined set of the parameters of PH value, watertemperature, ammonia (NH3), ammonium (NH4+), nitrate (NO3-), nitrite (NO2-), nitrous acid (NO2), hydrogen sulfide (H2S), salinity, electric conductivity (EC), Carbon/Nitrogen (C/N), alkalinity, hardness (GH/dKH/kH), total ammonia nitrogen (TN), total phosphate (TP), total organic carbon (TOC), oxidization reduction potential (ORP), total suspended solids (TSS), total dissolved solids (TDS), chemical oxygen demand (COD), biological oxygen demand(BOD), total bacterial concentration, heterotrophic bacteria, Escherichia coli, coliform bacteria, cyanobacteria, phytoplankton, chlorophyll A, residual chlorine and chlorine concentration, silicate (SiO4), sulfate (SO4), phosphate (PO4), transparency (SD), turbidity, calcium (CA), magnesium (Mg), calcium carbonate, dissolved oxygen (DO), trihalomethanes, ozone (O3), grease, heavy metal concentration: arsenic (As), cadmium (Cd), copper (Cu), manganese (Mn), sodium (Na), Potassium (K), fluorine (F), aluminum (Al), iron (Fe), lead (Pb), mercury (Hg), zinc (Zn), bromate, pseudomonas aeruginosa, staphylococcus aureus and vibrio.

For achieving the aforesaid objective, the process system of the water quality monitoring and maintaining system includes a monitoring module, a water quality adjustment deciding module. The monitoring module is electrically connected to the water quality adjustment deciding module, and the monitoring module is used for monitoring the plurality of water quality data, and sending the plurality of water quality data to the water quality adjustment deciding module when the plurality of water quality data have errors.

For achieving the aforesaid objective, the monitoring module of the water quality monitoring and maintaining system includes, but not limits to, a real-time data collecting module and an error data screening system. The real-time data collecting module is used for automatically correcting and storing the plurality of water quality data, and used for automatically establishing a water quality monitoring parameter model, and the error data screening system is used for identifying errors existed in the plurality of water quality data.

For achieving the aforesaid objective, the process system of the water quality monitoring and maintaining system further includes a monitored data base and a water quality managing module. The monitoring module is used for comparing the plurality of water quality data and the monitored data base for obtaining a comparing result; and the water quality adjustment deciding module adjusts the water quality according to the data in the water quality managing module after receiving the comparing result.

For achieving the aforesaid objective, the water quality treating module of the water quality monitoring and maintaining system includes, but not limits to, an automatic water quality treating system, a manual water quality treating illustrating module and a water quality treating result reporting module. The automatic water quality treating system, the manual water quality treating illustrating module and the water quality treating result reporting module are electrically connected to each other.

For achieving the aforesaid objective, the automatic water quality treating system of the water quality monitoring and maintaining system is connected to an automatic treating mechanism and a water circulating structure to perform a water quality treatment.

For achieving the aforesaid objective, the manual water quality treating illustrating module of the water quality monitoring and maintaining system is to provide a system operator or a processing personnel with illustrations and educations for the water quality treatment with a status including, but not limiting to, images, texts or audio/video.

For achieving the aforesaid objective, the water quality treating result reporting module of the water quality monitoring and maintaining system is used for determining an error correcting status and sending a report.

For achieving the aforesaid objective, the water quality monitoring and maintaining system further includes a personnel monitoring module including, but not limiting to, a system operating education module and a water quality monitoring and automatic water quality treating operation system. The system operating education module provides the system operator with all the system related operating and maintaining education, and the water quality monitoring and automatic water quality treating operation system provides the system operator with a water quality data monitoring interface.

### BRIEF DESCRIPTION OF THE DRAWINGS

FIG. 1 is a systematic schematic view showing the water quality monitoring and maintaining system according to the present invention;

FIG. 2 is a schematic view showing the water quality monitoring instrument of the water quality monitoring and maintaining system according to the present invention;

FIG. 3 is a schematic view showing the detecting zone of the water quality monitoring instrument of the water quality monitoring and maintaining system according to the present invention;

FIG. 4 is a schematic view showing the process system of the water quality monitoring and maintaining system according to the present invention;

FIG. 5 is a schematic view showing the water quality treating module of the water quality monitoring and maintaining system according to the present invention; and

FIG. 6 is a schematic view showing the personnel monitoring module of the water quality monitoring and maintaining system according to the present invention.

### BRIEF DESCRIPTION OF CODES

100: Water quality monitoring and maintaining system
200: Water quality monitoring instrument
210: Water inlet port
220: Detecting zone
221: Filtering and depositing tank
222: Separating tank
223: Flow channel
224: Optical detecting zone
225: Sterilizing tank
230: Communicating zone
240: Water outlet port
250: Expanding and culturing tank
300: Process system
310: Monitoring module
311: Real-time data collecting module
312: Error data screening system
320: Water quality adjustment deciding module
330: Monitored data base
340: Water quality managing module
400: Water quality treating module
410: Automatic water quality treating system
420: Manual water quality treating illustrating module
430: Water quality treating result reporting module
500: Personnel monitoring module
510: System operating education module
520: Water quality monitoring and automatic water quality treating operation system
W: Monitored water

### DETAILED DESCRIPTION OF THE PREFERRED EMBODIMENT

One preferred embodiment of the present invention will be described with reference to the drawings for illustrating the structural assembly, the technical means and the functions to be achieved by the present invention; and the actual ratios and the arrangement of components shall not be limited by the ratios and the arrangement of components in the provided figures.

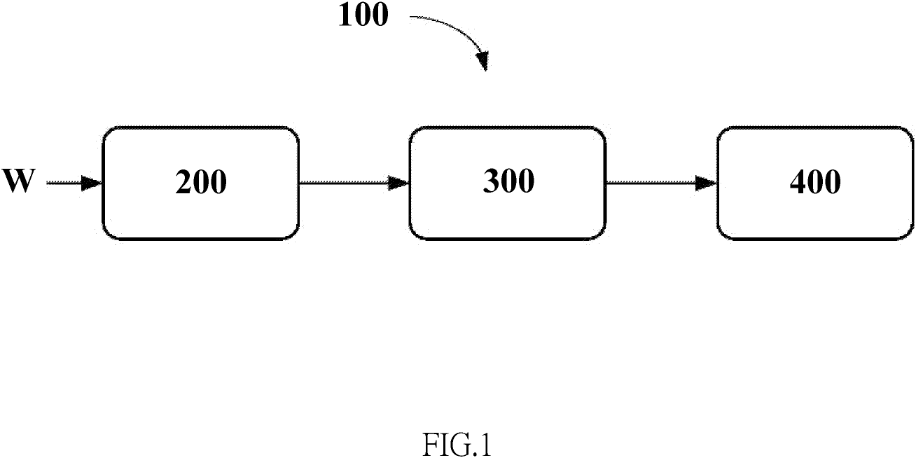

Please refer to FIG. 1, the present invention provides a water quality monitoring and maintaining system 100 including a water quality monitoring instrument 200, a process system 300 and a water quality treating module 400. The water quality monitoring instrument 200 is used for collecting a plurality of water quality data of a monitored water W in a monitored environment. The process system 300 is used for processing an error correcting and a storing operation for the plurality of water quality data collected by the water quality monitoring instrument 200, thereby establishing a water quality data model. The water quality treating module 400 is used for adjusting the plurality of water quality data of the monitored environment according to the water quality data model.

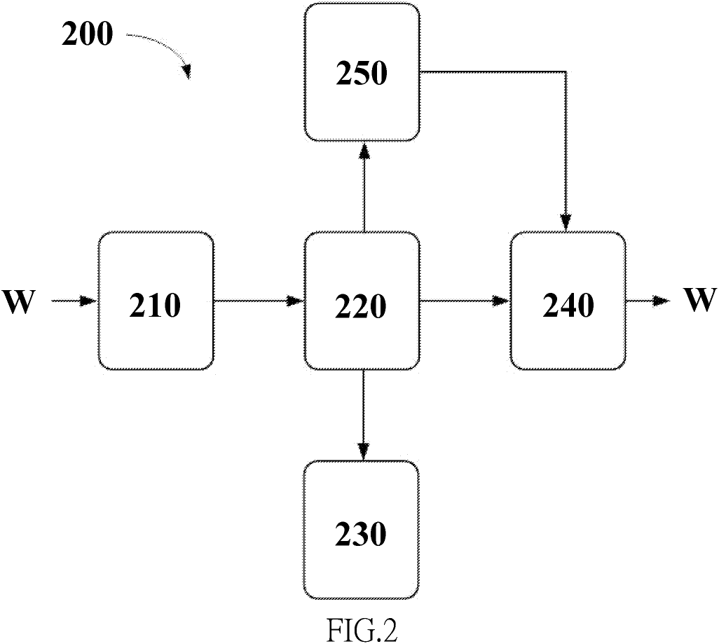

Please refer to FIG. 2, the water quality monitoring instrument 200 of the water quality monitoring and maintaining system 100 has a water inlet port 210, a detecting zone 220, a communicating zone 230 and a water outlet port 240. Fluids in the water inlet port 210, the detecting zone 220 and the water outlet port 240 are in communication with each other, and the detecting zone 220 is electrically connected to the communicating zone 230. The monitored water W flows into the detecting zone 220 from the water inlet port 210, the detecting zone 220 is served to analyze the monitored water W and send an analyzing result to the communicating zone 230, and then the monitored water W in the detecting zone 220 flows out from the water outlet port 240.

As shown in FIG. 2, the water quality monitoring instrument 200 of the water quality monitoring and maintaining system 100 further has an expanding and culturing tank 250, the installation of the expanding and culturing tank 250 is to expand and culture organic substances and inorganic substances for monitoring the amount of germs and viruses contained in the monitored water W.

Wherein, the step of allowing the monitored water W to flow in from the water inlet port 210 can be alternatively achieved by utilizing a water pump, but what shall be addressed is that the scope of the present invention is not limited to the above-mentioned arrangement.

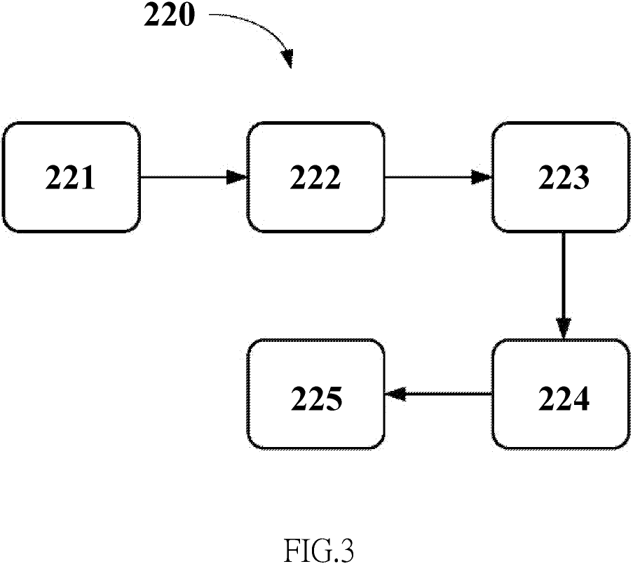

Please refer to FIG. 3, the detecting zone 220 of the water quality monitoring and maintaining system 100 has a filtering and depositing tank 221, a separating tank 222, a flow channel 223, an optical detecting zone 224 and a sterilizing tank 225. The filtering and depositing tank 221, the separating tank 222, the flow channel 223, the optical detecting zone 224 and the sterilizing tank 225 sequentially allows the fluid to pass for enabling the monitored water W to flow in or flow out, wherein the monitored water W firstly enters the filtering and depositing tank 221 for being filtered and deposited and then enters the separating tank 222; then, a peristaltic motor is used for providing a fluid flowing power to the monitored water W so as to enter the flow channel 223, meanwhile the monitored water W is mixed with a detecting reagent; the optical detecting zone 224 utilizes an optical detecting means to analyze the monitored water W mixed with the detecting reagent, lastly the monitored water W mixed with the detecting reagent is sterilized in the sterilizing tank 225, and then the monitored water W is discharged back to the monitored environment; the above-mentioned detecting processes to the monitored water W are able to effectively analyze the plurality of water quality data, and the discharged monitored water W can be prevented from polluting the monitored environment.

What shall be addressed is that: the plurality of water quality data of the monitored water W collected by the water quality monitoring instrument 200 include, but not limit to, single parameter or any combined set of the parameters of PH value, water temperature, ammonia (NH3), ammonium (NH4+), nitrate (NO3-), nitrite (NO2-), nitrous acid (NO2), hydrogen sulfide (H2S), salinity, electric conductivity (EC), Carbon/Nitrogen (C/N), alkalinity, hardness(GH/dKH/kH), total ammonia nitrogen (TN), total phosphate (TP), total organic carbon (TOC), oxidization reduction potential (ORP), total suspended solids (TSS), total dissolved solids (TDS), chemical oxygen demand (COD), biological oxygen demand(BOD), total bacterial concentration, heterotrophic bacteria, Escherichia coli, coliform bacteria, cyanobacteria, phytoplankton, chlorophyll A, residual chlorine and chlorine concentration, silicate (SiO4), sulfate (SO4), phosphate (PO4), transparency (SD), turbidity, calcium (CA), magnesium (Mg), calcium carbonate, dissolved oxygen (DO), trihalomethanes, ozone (O3), grease, heavy metal concentration: arsenic (As), cadmium (Cd), copper (Cu), manganese (Mn), sodium (Na), Potassium (K), fluorine (F), aluminum (Al), iron (Fe), lead (Pb), mercury (Hg), zinc (Zn), bromate, pseudomonas aeruginosa, staphylococcus aureus and vibrio.

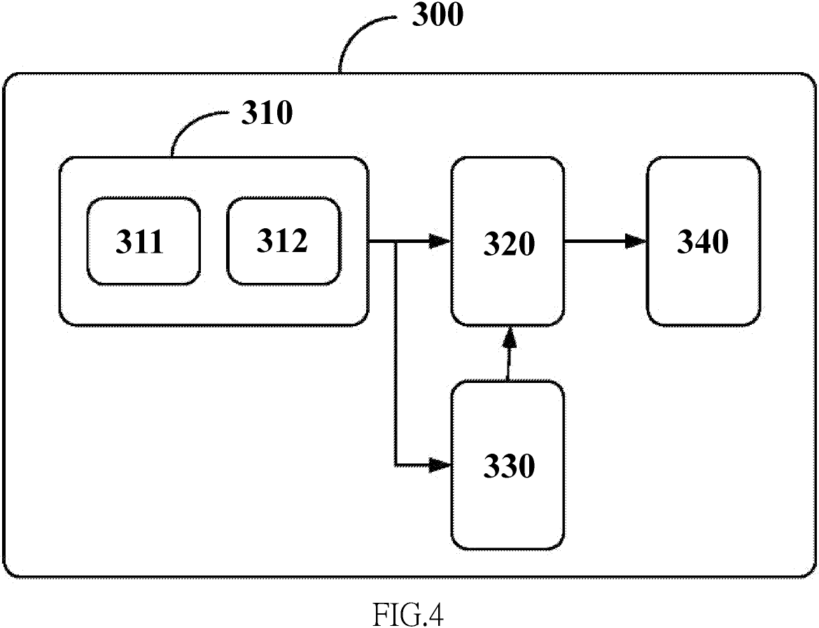

Please refer to FIG. 4, the process system 300 includes a monitoring module 310, a water quality adjustment deciding module 320, a monitored data base 330 and a water quality managing module 340. The monitoring module 310 is electrically connected to the water quality adjustment deciding module 320, and the monitoring module 310 is used for monitoring the plurality of water quality data, and sending the plurality of water quality data to the water quality adjustment deciding module 320 when the plurality of water quality data have errors; meanwhile the monitoring module 310 is used for comparing the plurality of water quality data and the monitored data base 330 for obtaining a comparing result; and the water quality adjustment deciding module 320 is able to adjust the water quality according to the data in the water quality managing module 340 after receiving the comparing result.

Wherein the monitoring module 310 includes, but not limits to, a real-time data collecting module 311 and an error data screening system 312. The real-time data collecting module 311 is used for automatically correcting and storing the plurality of water quality data, and used for automatically establishing a water quality monitoring parameter model, and the error data screening system 312 is used for identifying errors existed in the plurality of water quality data.

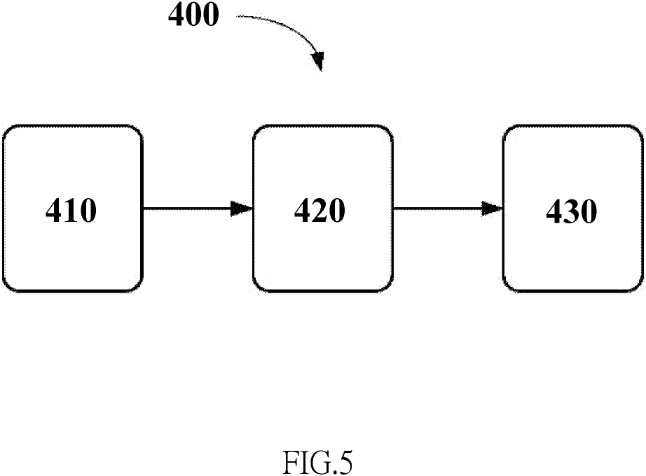

Please refer to FIG. 5, the water quality treating module 400 of the water quality monitoring and maintaining system 100 includes, but not limits to, an automatic water quality treating system 410, a manual water quality treating illustrating module 420 and a water quality treating result reporting module 430. The automatic water quality treating system 410, the manual water quality treating illustrating module 420 and the water quality treating result reporting module 430 are electrically connected to each other.

Wherein, the automatic water quality treating system 410 of the water quality treating module 400 is connected to an automatic treating mechanism and a water circulating structure to perform a water quality treatment, the automatic water quality treating means includes, but not limits to, automatic water inlet outlet port controlling, automatic dirt discharging equipment controlling, automatic feeding amount controlling, automatic inputting improvement substances equipment controlling (including, but not limiting to lime or sugar), thereby finishing the water quality treatment.

The manual water quality treating illustrating module 420 is to provide a system operator or a personnel going to the filed with illustrations including, but not limiting to, images, texts or audio/video via a device including, but not limiting to, a smart phone, a tablet computer, a computer or a mobile device, a wearable device for methods and educations of water quality treatment when the automatic water quality treating process is not available, so that a situation of a personnel going to the field with no experience being unable to perform the water quality treating operation can be avoided.

The water quality treating result reporting module 430 is used for deciding the water quality improvement result through determining an error correcting status after the water quality treatment has been finished, and the water quality improvement result is reported to the system operator.

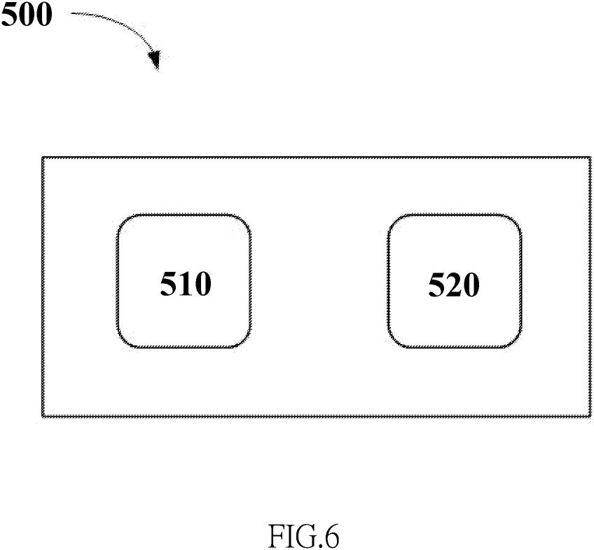

Please refer to FIG. 6, the water quality monitoring and maintaining system 100 of the present invention further includes a personnel monitoring module 500. The personnel monitoring module 500 allows the system operator to understand the system operating education, to obtain the real-time water quality monitoring and detecting data and to provide manually operating the automatic water quality treating module through the monitoring module 310 of the module. The personnel monitoring module 500 includes, but not limits to, a system operating education module 510 and a water quality monitoring and automatic water quality treating operation system 520. The system operating education module 510 provides the system operator with all the system related operating and maintaining education, including, but not limiting to, presenting means of monitored and detected data of the system, adjusting means of the monitored or detected data and the water quality monitoring instrument maintaining and operating procedure; the data providing mans of the education module includes, but not limits to, statuses of images, texts or audio/video. The water quality monitoring and automatic water quality treating operation system 520 provides the system operator with a water quality data monitoring interface and an manual controlling function required by the system operator; with the installation of the water quality monitoring and automatic water quality treating operation system 520, the system operator is able to remotely and manually operate the automatic equipment when a critical situation happens, and the water quality monitored data and the water condition in each cultivating farm may be remotely monitored at any desired time and place, so that an objective of comprehensively monitoring the whole cultivating conditions may be achieved.

According to the present invention, the water quality monitoring and maintaining system 100 further includes extended applications including “educating the water quality monitoring instrument operating procedure from cloud”, “eliminating the contaminants for the cultivating creature in water and analyzing possible affections to human beings”, “monitoring and detecting water quality, establishing data model”, and “real-time data displaying and notifying the system operator while a plurality of water quality monitoring instruments being operated”.

Wherein, the “educating the water quality monitoring instrument operating procedure from cloud” can be provided with statuses including, but not limiting to, images, texts or audio/video, so that system operator or the personnel in charge of operating the water quality monitoring instrument can understand the operating procedure of the water quality monitoring instrument after entering the backstage monitoring module.

The “eliminating the contaminants for the cultivating creature in water and analyzing possible affections to human beings” is to expand and culture the organic substances and the inorganic substances which are monitored by the system, and compared with the monitored data base 330 of the system specifically to the organic substances and the inorganic substances harmful to the cultivated creatures or the human beings (the organic substances and the inorganic substances including, but not limiting to, arsenic: black foot disease, chromium: inducing cancer, cadmium: itai-itai disease, mercury: water conservation disease, nitrate: blue boy syndrome, trihalomethanes: inducing cancer) thereby adjusting and providing a matched reagent for detections, and a dosage analyze is processed and continuously monitored, and the water quality treating module 400 is used for treating the water quality when an over dosing situation happens, thereby eliminating the harmful substances and lowering the contaminant dangers to the cultivating creatures and the human beings.

The “monitoring and detecting water quality, establishing data model” is to integrate the monitored data and other data recordings related factors (including, not but limiting to, the cultivating creatures in the frame, seasons, water temperatures, date, time, the structure of cultivating farm, the amount of water stored in the cultivating farm, the operating condition and the cleaning frequency of the cultivating farm and maintaining status of the cultivating farms) to establish the water quality data model, so that the system can be provided with a certain data foundation and model while facing the unusual water quality condition in the future, and the water quality adjustment deciding module 320 is able to make a precise water quality adjustment solution.

The “real-time data displaying and notifying the operator while a plurality of water quality monitoring instruments being operated” is able to connect a plurality of the water quality monitoring instruments or other monitoring instruments to provide all the affecting factors of the cultivating process, the real-time monitored data and historical data for the purposes of adjusting and analyzing; with the plurality of instruments used for monitoring at the same time, the system operator can be aware of the current condition of the whole cultivating farms, or to process an evaluation regarding to zones which often have problems thereby preventing the same problems from occurring repeatedly.

Moreover, the water quality monitoring and maintaining system 100 is provided with an AI water quality treatment deciding procedure, the water quality adjustment deciding module 310 can be used for processing a systematic AI calculation to error situations of the current water quality monitored and detected data according to the data model established by the “monitoring and detecting water quality, establishing data model”; with the real-time calculation and the water quality treating decision, the cultivating environment of the cultivating creature can be effectively kept in an optimal status, and with the reactions based on the real-time data monitoring and detecting, the reaction time of conventional manual operation can be shortened, and the economic value and surviving rate of the cultivating creature can be increased.

According to the present invention, the water quality monitoring and maintaining system 100 is further provided with a detecting and monitoring method for ammonia nitrogen in water, the water quality monitoring instrument 200 can be used for working with a treating method including, but not limiting to, an ion chromatographing method (detecting negative ions in water), a cadmium reduction flow injection analyzing method (detecting nitrate nitrogen and nitrite nitrogen in water), a cadmium reduction method (detecting nitrate nitrogen and nitrite nitrogen in water), a strychnine colorimetric method (detecting nitrate in water), an indophenol-like method (Kjeldahl nitrogen flowing and injecting analyze), an indophenol colorimetric method (detecting ammonia nitrogen in water), an indophenol method (ammonia nitrogen in water flowing and injecting analyze) and an ammonia selective electrode method (detecting ammonia nitrogen in water); by detecting and monitoring and controlling the ammonia nitrogen concentration in the water quality, the ammonia nitrogen can be maintained within a safe range, so that the biological chronic poisoning can be prevented from the overly-high concentration of the ammonia nitrogen; wherein the total nitrogen in water capable of being detected and monitored includes, but not limits to, nitrate nitrogen, nitrite nitrogen and Kjeldahl nitrogen; with the method provided by the present invention, the positioning caused by the total nitrogen to the creatures can be deceased, and the surviving rate of the creature and the food safety regarding to the cultivating creature can be greatly improved.

According to the present invention, the water quality monitoring and maintaining system 100 is further provided with an abnormal water quality phenomena reporting, the error data screening system 312 can be used for automatic reporting the error status to the system operator via the personnel monitoring module 500 when the system detects and monitors the water quality monitored or detected data exceeds the error tolerance, and a decision suggestion according to the water quality adjustment deciding module 320 is provided to allow the system operator to know the abnormal zone and reasons at the first place, and the system can be set to automatically decide the treatment, or other operating personnel can go to the field to know the actual condition, so that the possible affections of having the cultivating creature harvesting rate being behind the schedule or even being lost due to water quality can be controlled to the minimum.

According to the present invention, the water quality monitoring and maintaining system 100 is further provided with a chemical colorimetric method (spectrophotometer) for detecting and monitoring the water quality, the water quality monitoring instrument 200 can be used for processing a chemical colorimetric method (spectrophotometer) for detecting and monitoring the water quality, a chemical reagent (solvent) corresponding to the desired detecting and monitoring items is firstly prepared, and then the reagent is filled in the detected and monitored water, with the colorimeter (spectrophotometer) detecting the absorbance which is converted into the water concentration, the obtained data is uploaded to the system to be recorded, thereby finishing the whole chemical colorimetric method for detecting and monitoring the water quality

Based on what has been disclosed above, the water quality monitoring and maintaining system 100 has advantages as follows. The labor consumption during the water quality monitoring process can be decreased, and the system operator is provided with the data to monitor and control the current water quality for the whole cultivating farms at the same time, and the automatic solution can be provided to the zone where the water quality has changed so as to achieve the water quality treating process, meanwhile with the establishment of the water quality data model, the system is able to draft a solution for a certain zone where the water quality has yet to be abnormal; the system is able to directly link the monitored status obtained by the water quality monitoring instrument with the treating module of the system, thereby providing an automatic and comprehensive solution for the water quality monitoring and treating.

Moreover, the conventional equipment adopted as the water quality monitoring instrument is mostly handheld, thus the labor is necessary wasted, and the water quality monitoring and detecting capability is affected by the size of the equipment, the range which is able to be monitored and detected is very much limited, thereby causing a poor efficiency; if a plurality of locations are required to be detected and monitored in real time, a plurality sets of operators and a plurality of monitoring machines are required, and problems such as time difference and not responding in time may happen if the detecting distance is overly large; according to the present invention, the water quality monitoring instrument 200 is used for introducing the water so as to be monitored, thus only one water quality monitoring instrument is needed to introducing water from a plurality of locations to process the water quality detecting and monitoring process, and with the network connecting function, the monitored data can be fed back in real time, thereby shortening the monitoring time difference and lowering the possibilities of wrong doings caused by the manual detecting and monitoring operations.

On the other hand, the conventional water quality monitoring instrument utilizes an electrode method to perform the water quality detecting and monitoring process, but the electrode method has disadvantages as followings: if a plurality of data are desired to be detected and monitored, the electrode state or frequency are required to be changed; as such, with a single instrument, the process of detecting and monitoring the plurality of parameters of the water quality cannot be performed; according to the present invention, the chemical colorimetric method (spectrophotometer) is adopted for detecting and monitoring the water quality, so that the chemical reagent corresponding to the desired detecting and monitoring items can be prepared for performing the detecting and monitoring process; with respect to a situation of additional items being required for detecting and monitoring the water quality or certain desired detecting value being required by the system or the customer end, the desired items can be automatically updated or manually added in the water quality monitoring instrument for the purpose of detecting and monitoring; accordingly, the system has an advantage of greatly reducing to single water quality monitoring instrument comparing to the plurality of conventional water quality monitoring instruments, thereby lowering the maintaining and the purchasing cost of the water quality monitoring instrument.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A water quality monitoring and maintaining system, including:
a water quality monitoring instrument, used for collecting a plurality of water quality data of a monitored water in a monitored environment;
a process system, used for processing an error correcting operation and a storing
operation for the plurality of water quality data collected by the water quality monitoring instrument, thereby establishing a water quality data model; and
a water quality treating module, used for adjusting the plurality of water quality data of the monitored environment according to the water quality data model.

2. The water quality monitoring and maintaining system as claimed in claim 1, wherein the water quality monitoring instrument has a water inlet port, a detecting zone, a communicating zone and a water outlet port; fluids in the water inlet port, the detecting zone and the water outlet port are in communication with each other, the detecting zone is electrically connected to the communicating zone, the monitored water flows into the detecting zone from the water inlet port, the detecting zone is served to analyze the monitored water and send an analyzing result to the communicating zone, and the monitored water in the detecting zone flows out from the water outlet port.

3. The water quality monitoring and maintaining system as claimed in claim 2, wherein the water quality monitoring instrument further has an expanding and culturing tank, the expanding and culturing tank is used for expanding and culturing organic substances and inorganic substances for monitoring the amount of germs and viruses contained in the monitored water.

4. The water quality monitoring and maintaining system as claimed in claim 2, wherein the detecting zone has a filtering and depositing tank, a separating tank, a flow channel, an optical detecting zone and a sterilizing tank; the filtering and depositing tank, the separating tank, the flow channel, the optical detecting zone and the sterilizing tank sequentially allows the fluid to pass for enabling the monitored water to flow in or flow out.

5. The water quality monitoring and maintaining system as claimed in claim 1, wherein the plurality of water quality data include, but not limit to, single parameter or any combined set of the parameters of PH value, water temperature, ammonia (NH3), ammonium (NH4+), nitrate (NO3-), nitrite (NO2-), nitrous acid (NO2), hydrogen sulfide (H2S), salinity, electric conductivity (EC), Carbon/Nitrogen (C/N), alkalinity, hardness(GH/dKH/kH), total ammonia nitrogen (TN), total phosphate (TP), total organic carbon (TOC), oxidization reduction potential (ORP), total suspended solids (TSS), total dissolved solids (TDS), chemical oxygen demand (COD), biological oxygen demand(BOD), total bacterial concentration, heterotrophic bacteria, Escherichia coli, coliform bacteria, cyanobacteria, phytoplankton, chlorophyll A, residual chlorine and chlorine concentration, silicate (SiO4), sulfate (SO4), phosphate (PO4), transparency (SD), turbidity, calcium (CA), magnesium (Mg), calcium carbonate, dissolved oxygen (DO), trihalomethanes, ozone (O3), grease, heavy metal concentration: arsenic (As), cadmium (Cd), copper (Cu), manganese (Mn), sodium (Na), Potassium (K), fluorine (F), aluminum (Al), iron (Fe), lead (Pb), mercury (Hg), zinc (Zn), bromate, pseudomonas aeruginosa, staphylococcus aureus and vibrio.

6. The water quality monitoring and maintaining system as claimed in claim 1, wherein the process system includes a monitoring module, a water quality adjustment deciding module; the monitoring module is electrically connected to the water quality adjustment deciding module, and the monitoring module is used for monitoring the plurality of water quality data, and sending the plurality of water quality data to the water quality adjustment deciding module when the plurality of water quality data have errors.

7. The water quality monitoring and maintaining system as claimed in claim 6, wherein the monitoring module includes, but not limits to, a real-time data collecting module and an error data screening system; the real-time data collecting module is used for automatically correcting and storing the plurality of water quality data, and used for automatically establishing a water quality monitoring parameter model, and the error data screening system is used for identifying errors existed in the plurality of water quality data.

8. The water quality monitoring and maintaining system as claimed in claim 7, wherein the process system further includes a monitored data base and a water quality managing module; the monitoring module is used for comparing the plurality of water quality data and the monitored data base for obtaining a comparing result, and the water quality adjustment deciding module is used for adjusting the water quality according to the data in the water quality managing module after receiving the comparing result.

9. The water quality monitoring and maintaining system as claimed in claim 1, wherein the water quality treating module includes, but not limits to, an automatic water quality treating system, a manual water quality treating illustrating module and a water quality treating result reporting module; the automatic water quality treating system, the manual water quality treating illustrating module and the water quality treating result reporting module are electrically connected to each other.

10. The water quality monitoring and maintaining system as claimed in claim 9, wherein the automatic water quality treating system is connected to an automatic treating mechanism and a water circulating structure to perform a water quality treatment.

11. The water quality monitoring and maintaining system as claimed in claim 9, wherein the manual water quality treating illustrating module is to provide a system operator or a processing personnel with illustrations and educations for the water quality treatment with a status including, but not limiting to, images, texts or audio/video.

12. The water quality monitoring and maintaining system as claimed in claim 9, wherein the water quality treating result reporting module of the water quality monitoring and maintaining system is used for determining an error correcting status and sending a report.

13. The water quality monitoring and maintaining system as claimed in claim 1, further including a personnel monitoring module including, but not limiting to, a system operating education module and a water quality monitoring and automatic water quality treating operation system; the system operating education module provides the system operator with all the system related operating and maintaining education, and the water quality monitoring and automatic water quality treating operation system provides the system operator with a water quality data monitoring interface.
